(19) United States
(12) Patent Application Publication
(10) Pub. No.: US 2015/0156575 A1
(43) Pub. Date: Jun. 4, 2015

(54) MICROPHONE PACKAGE AND METHOD OF MANUFACTURING THE SAME

(71) Applicant: Samsung Electro-Mechanics Co., Ltd., Suwon-Si (KR)

(72) Inventors: Tae Hyun KIM, Suwon-Si (KR); Heung Woo PARK, Suwon-Si (KR)

(73) Assignee: SAMSUNG ELECTRO-MECHANICS CO., LTD., Suwon-Si (KR)

(21) Appl. No.: 14/267,575

(22) Filed: May 1, 2014

(30) Foreign Application Priority Data
Dec. 2, 2013 (KR) 10-2013-0148667

(51) Int. Cl. H04R 1/04; H04R 31/00

(52) U.S. Cl. CPC H04R 1/04; H04R 31/00; H04R 2201/003

(57) ABSTRACT

There is provided a microphone package including: a microphone element formed on a semiconductor element; a mold enclosing the semiconductor element and the microphone element; and a conductive pattern formed on one surface of the mold and having a hole formed therein, the hole being connected to the microphone element.

### CROSS-REFERENCE TO RELATED APPLICATION

This application claims the benefit of Korean Patent Application No. 10-2013-0148667 filed on Dec. 2, 2013, with the Korean Intellectual Property Office, the disclosure of which is incorporated herein in its entirety by reference.

### BACKGROUND

The present technology generally relates to a microphone package and a method of manufacturing the same.

In accordance with the miniaturization of electronic products, accessories mounted in electronic products have gradually been miniaturized. Therefore, a micro-electromechanical system (MEMS) microphone has been prominent as a sound signal input apparatus widely used in mobile communications terminals, audio apparatuses, and the like.

MEMS microphones may be mainly classified as, for example, piezoresistive type MEMS microphones, piezoelectric type MEMS microphones, and condenser type MEMS microphones.

Since piezoresistive type MEMS microphones use a principle by which a resistance value is changed by vibrations, the resistance value may be changed depending on changes in surrounding environmental conditions (such as a change in temperature), such that a constant sound band frequency may not be maintained.

In addition, since piezoelectric type MEMS microphones use a piezoelectric effect generated at both ends of a diaphragm, an electrical signal is changed depending on pressure of an audio signal.

Condenser type MEMS microphones have a structure in which one of two metal flat plates is used as a fixed electrode, while the other of the two metal flat plates is used as a diaphragm vibrating in response to a sound signal, and an air gap of about several to several tens of micrometers (μms) is positioned between the two electrodes. Since the condenser type MEMS microphone measures changes in capacitance between the diaphragm and the fixed electrode when the diaphragm vibrates, depending on a sound source, stability and frequency characteristics of a transduced sound band are excellent.

Meanwhile, since the microphone is mounted in a package form in an electronic device, development of a microphone package appropriate for a small electronic device is required.

### SUMMARY

Some embodiments of the present disclosure may provide a microphone package capable of being easily mounted in an electronic device, and a method of manufacturing the same.

According to some embodiments of the present disclosure, a microphone package may include: a microphone element formed on a semiconductor element; a mold enclosing the semiconductor element and the microphone element; and a conductive pattern formed on one surface of the mold and having a hole formed therein, the hole being connected to the microphone element.

The mold may have a first connection electrode formed therein, the first connection electrode being connected to the semiconductor element.

The mold may have a second connection electrode formed therein, the second connection electrode being connected to an external ground electrode.

The microphone element may be connected to the conductive pattern.

The conductive pattern may be a circuit pattern forming one or more electrical circuits.

The conductive pattern may shield harmful electromagnetic waves.

The conductive pattern may have a form of a lead frame including a lead pin connected to at least one of the microphone element and the semiconductor element.

The mold may have first and third connection electrodes formed therein, the first and third connection electrodes being connected to the semiconductor element and the microphone element, respectively, and the conductive pattern may include one or more circuit patterns connecting the first and third connection electrodes to each other.

The microphone element may be disposed on one surface of the semiconductor element.

The semiconductor element may have a sound chamber formed therein, the sound chamber being connected to the microphone element and being used as a reverberating space for sound waves.

The semiconductor element may have a through hole formed therein, the through hole being connected to the microphone element.

The semiconductor element may have a sound chamber and a through hole formed therein, the sound chamber being used as a reverberating space for sound waves, and the through hole being connected to the sound chamber.

The microphone element may be any one of a piezoresistive type microphone element, a piezoelectric type microphone element, and a condenser type microphone element.

According to another aspect of the present disclosure, a method of manufacturing a microphone package may include: forming a microphone element on a semiconductor element; forming a lead frame having a lead pin connected to at least one of the semiconductor element and the microphone element; and forming a mold between the lead frame, and the semiconductor element and the microphone element.

The method of manufacturing a microphone package may further include forming a solder ball on the lead pin.

According to some embodiments of the present disclosure, a method of manufacturing a microphone package may include: forming a microphone element on a semiconductor element; forming a mold accommodating the semiconductor element and the microphone element therein; forming one or more connection electrodes in the mold; and forming a conductive pattern on the mold, the conductive pattern being connected to the connection electrodes.

The method of manufacturing a microphone package may further include forming a sound chamber in the semiconductor element, the sound chamber being used as a reverberating space for sound waves.

The method of manufacturing a microphone package may further include forming a through hole connected to the microphone element while penetrating through the semiconductor element.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a microphone package according to an exemplary embodiment of the present disclosure;

FIG. 2 is a cross-sectional view showing another form of the microphone package shown in FIG. 1;

FIG. 3 is a cross-sectional view showing another form of the microphone package shown in FIG. 1;

FIG. 4 is a cross-sectional view showing another form of the microphone package shown in FIG. 1;

FIG. 5 is a cross-sectional view showing another form of the microphone package shown in FIG. 1;

FIG. 6 is a cross-sectional view showing another form of the microphone package shown in FIG. 1;

FIG. 7 is a cross-sectional view showing another form of the microphone package shown in FIG. 1;

FIG. 8 is a cross-sectional view showing another form of the microphone package shown in FIG. 1;

FIG. 9 is a cross-sectional view showing another form of the microphone package shown in FIG. 1;

FIG. 10 is a view showing a method of manufacturing a microphone package according to an exemplary embodiment of the present disclosure;

FIG. 11 is a cross-sectional view showing another form of the method of manufacturing a microphone package shown in FIG. 10; and

FIG. 12 is a view showing a method of manufacturing a microphone package according to another exemplary embodiment of the present disclosure.

### DETAILED DESCRIPTION

Exemplary embodiments of the present disclosure will now be described in detail with reference to the accompanying drawings.

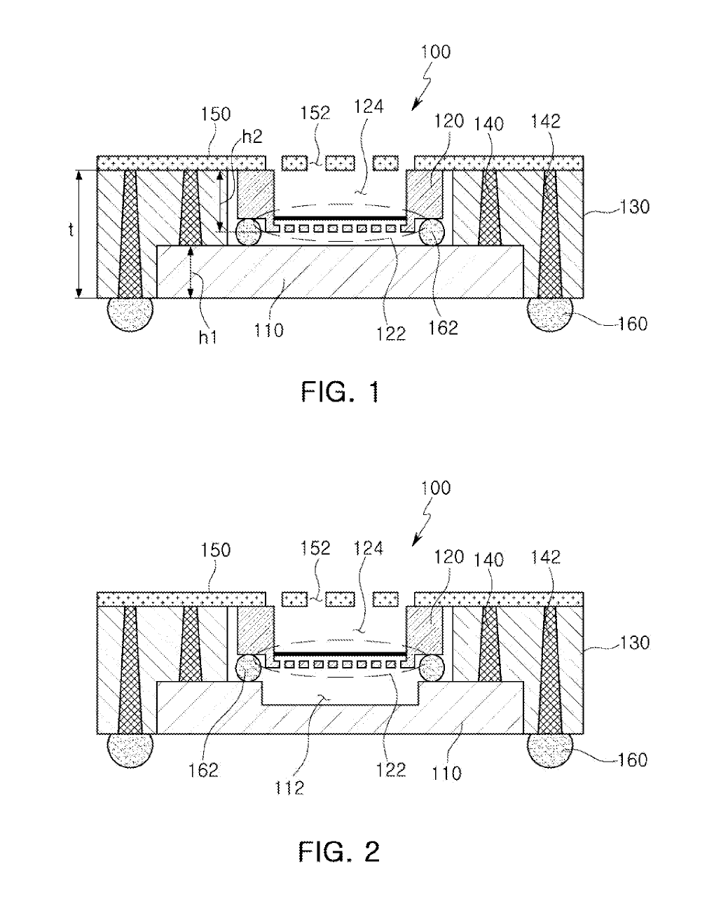

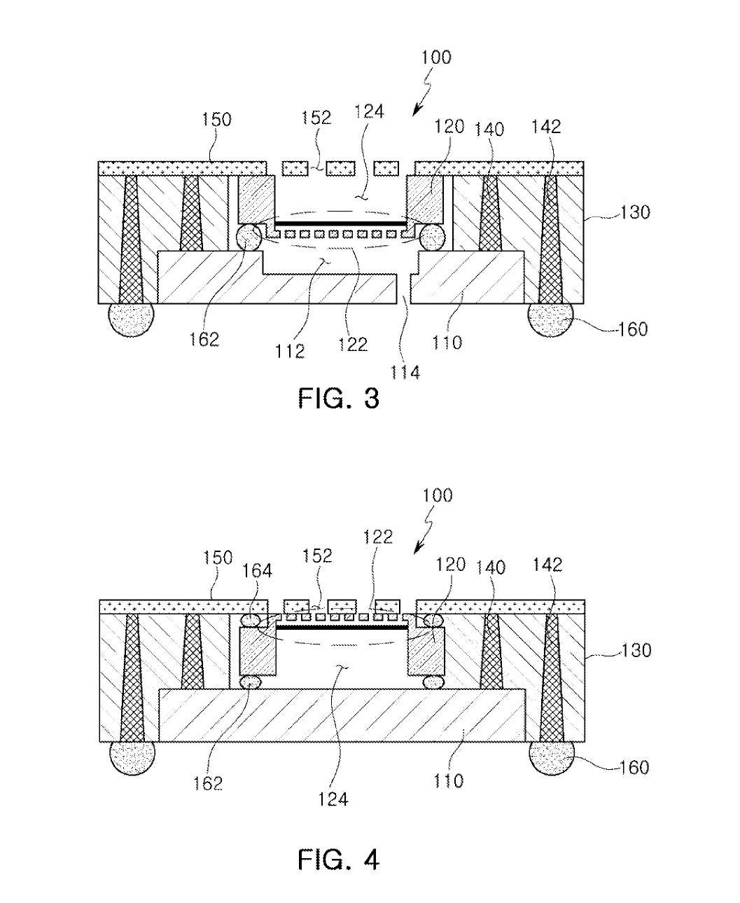

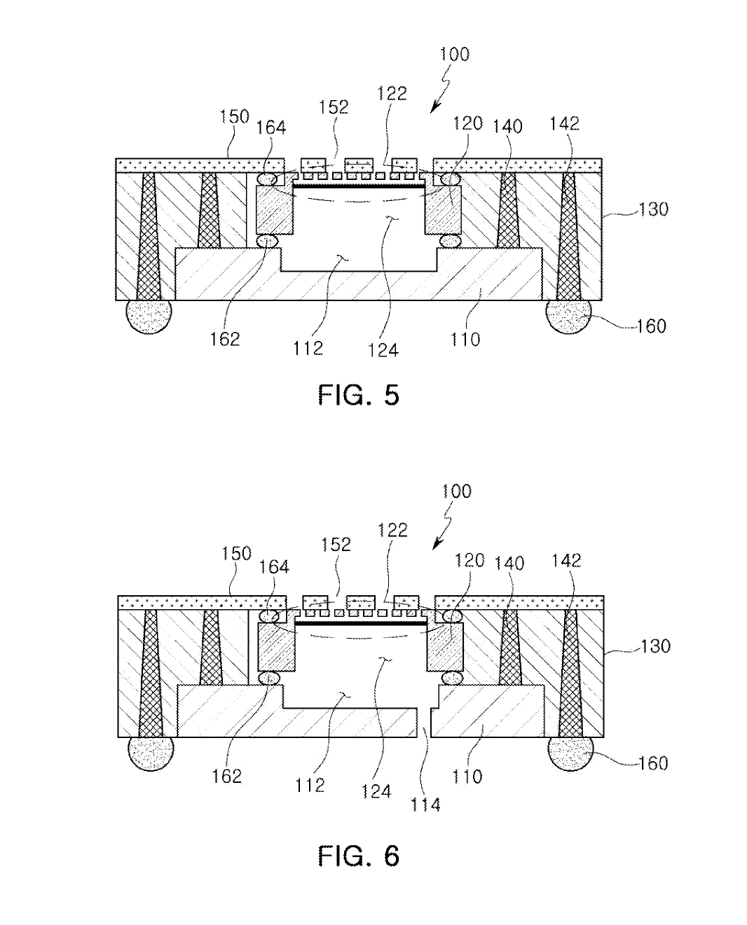

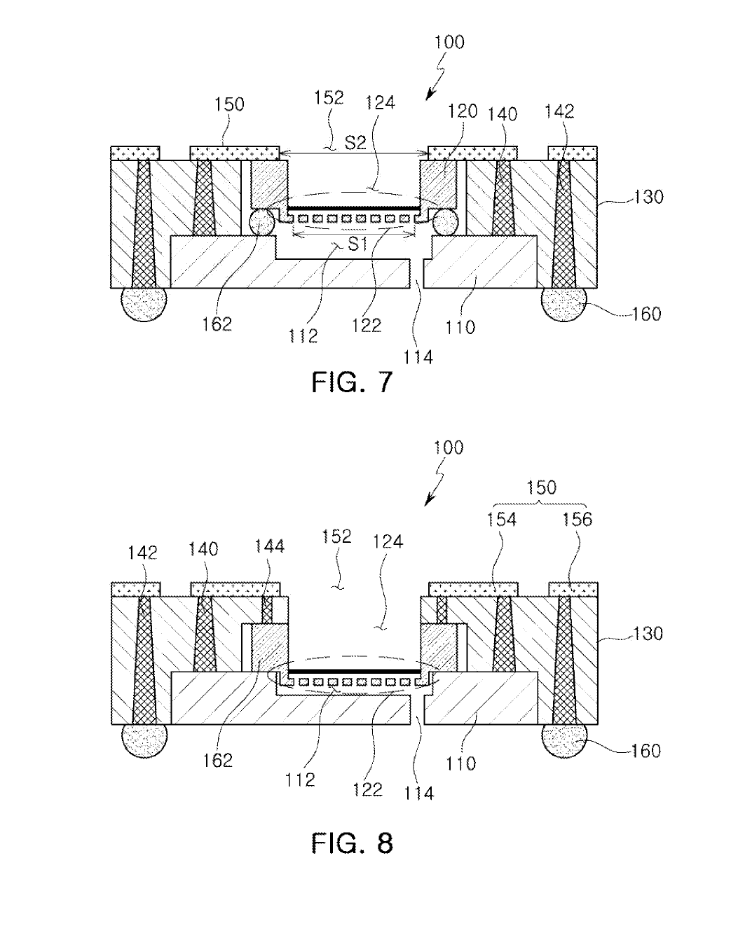

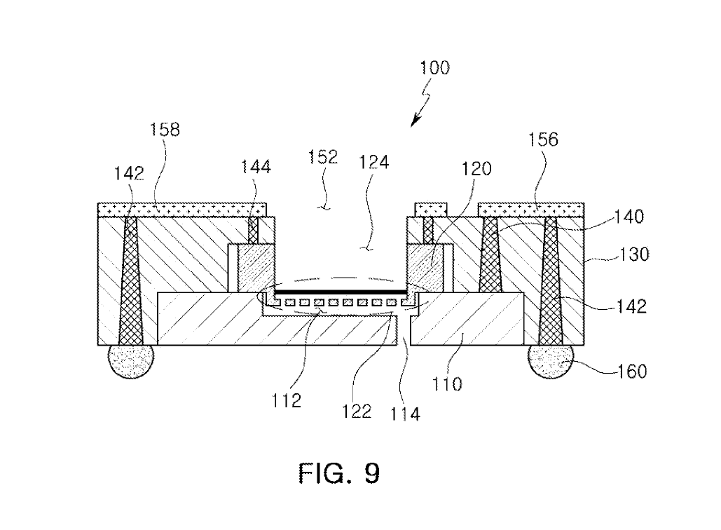

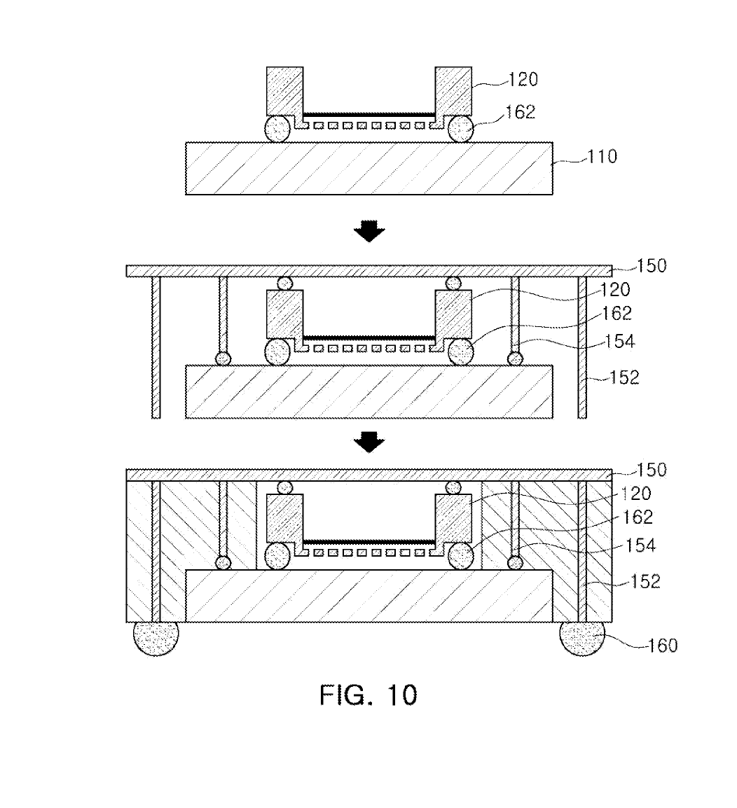

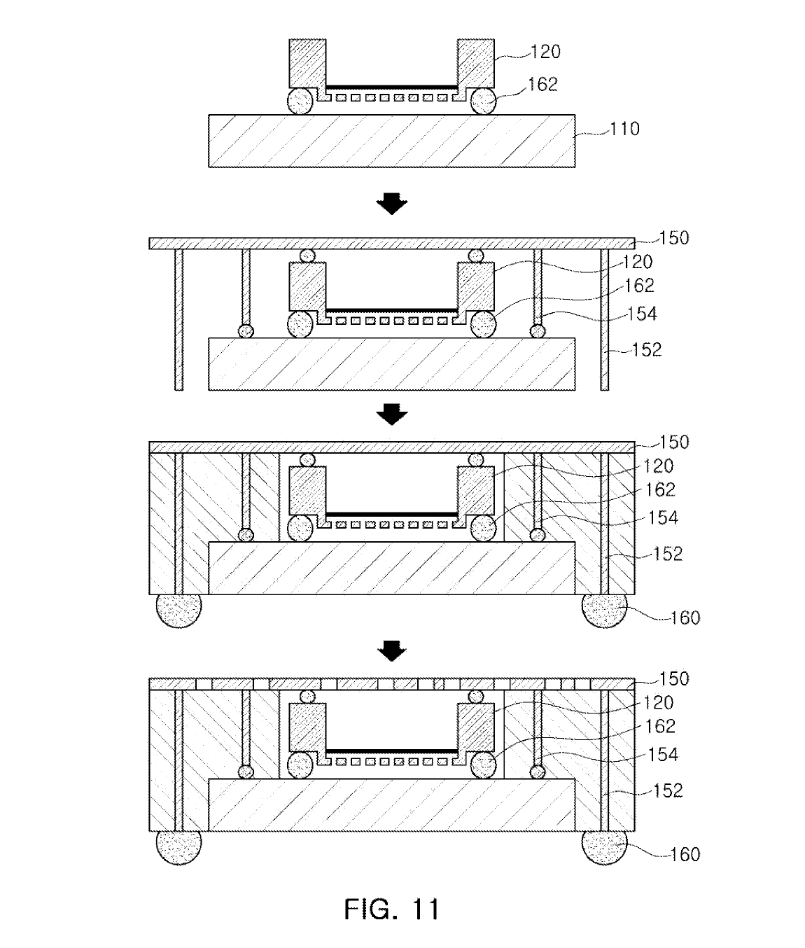

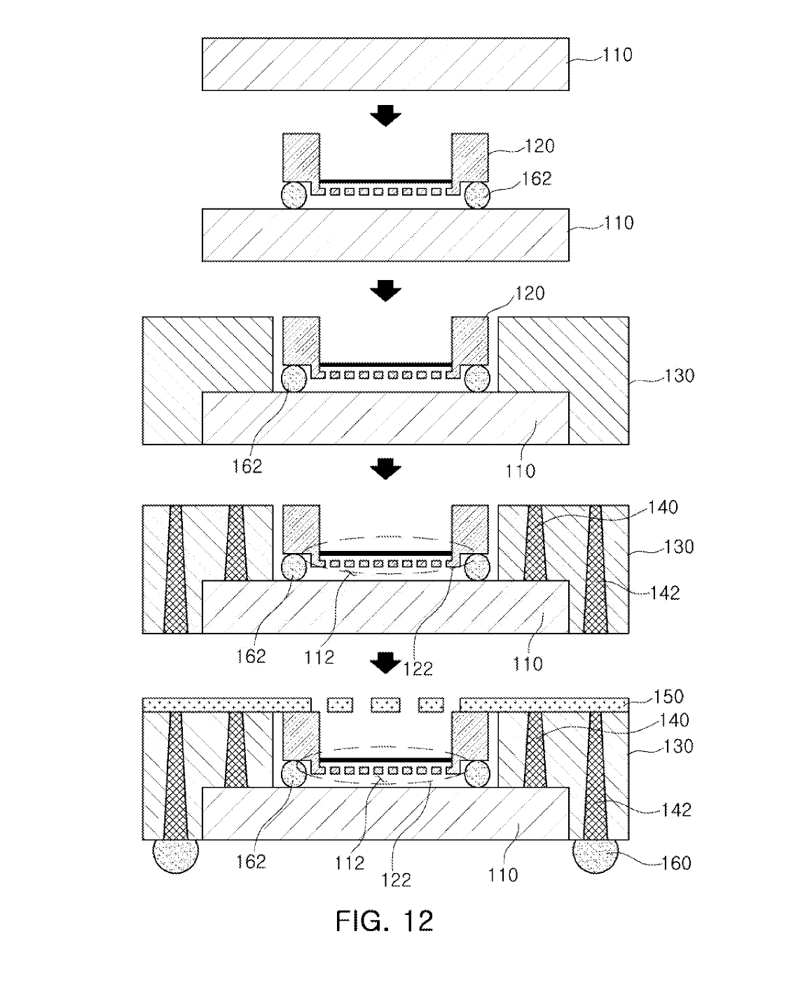

FIG. 1 is a cross-sectional view of a microphone package according to an exemplary embodiment of the present disclosure; FIG. 2 is a cross-sectional view showing another form of the microphone package shown in FIG. 1; FIG. 3 is a cross-sectional view showing another form of the microphone package shown in FIG. 1; FIG. 4 is a cross-sectional view showing another form of the microphone package shown in FIG. 1; FIG. 5 is a cross-sectional view showing another form of the microphone package shown in FIG. 1; FIG. 6 is a cross-sectional view showing another form of the microphone package shown in FIG. 1; FIG. 7 is a cross-sectional view showing another form of the microphone package shown in FIG. 1; FIG. 8 is a cross-sectional view showing another form of the microphone package shown in FIG. 1; FIG. 9 is a cross-sectional view showing another form of the microphone package shown in FIG. 1; FIG. 10 is a view showing a method of manufacturing a microphone package according to an exemplary embodiment of the present disclosure; FIG. 11 is a cross-sectional view showing another form of the method of manufacturing a microphone package shown in FIG. 10; and FIG. 12 is a view showing a method of manufacturing a microphone package according to another exemplary embodiment of the present disclosure.

A microphone package according to an exemplary embodiment of the present disclosure will be described with reference to FIG. 1.

The microphone package 100 according to the present exemplary embodiment may include a semiconductor element 110, a microphone element 120, and a mold 130. In addition, the microphone package 100 may include a conductive pattern 150. Further, the microphone package 100 may include connection electrodes 140 and 142. Further, the microphone package 100 may include solder balls 160 and 162. Here, the solder balls 160 and 162 may be omitted.

The microphone package 100 configured as described above may be mounted in an electronic device. For example, the microphone package 100 may be mounted in a mobile phone, a digital camera, or the like. In addition, the microphone package 100 may be mounted directly on a circuit board. To this end, the microphone package 100 may have an external connection terminal. For example, the microphone package 100 may include a plurality of solder balls 160 formed thereon.

Next, main components of the microphone package 100 will be described.

The semiconductor element 110 may include one or more arithmetic circuits. For example, the semiconductor element 110 may include an arithmetic circuit converting vibrations of a diaphragm into an electrical signal. In addition, the semiconductor element 110 may further include an arithmetic circuit amplifying the converted electrical signal. Further, the semiconductor element 110 may further include an arithmetic circuit removing or decreasing vibrations generated due to noise. For example, the semiconductor element 110 may be an application specific integrated circuit (ASIC). Therefore, the semiconductor element 110 may be changed depending on a type of the microphone element 120.

Meanwhile, although the case in which the microphone package 100 includes only one semiconductor element 110 has been shown in FIG. 1, the microphone package 100 may include two or more semiconductor elements 110, if necessary. In this case, an added semiconductor element 110 may perform functions other than the above-mentioned functions.

The microphone element 120 may sense a sound wave. For example, the microphone element 120 may sense vibrations in an audio frequency band. In addition, the microphone element 120 may convert the sensed vibrations into an electrical signal. To this end, the microphone element 120 may include a vibrating part 122. For example, the vibrating part 122 may have a piezoresistive structure sensing vibrations of a thin film member as a resistance. Alternatively, the vibrating part 122 may have a piezoelectric structure sensing the vibrations of the thin film member as a displacement of a piezoelectric element. Alternatively, the vibrating part 122 may have a capacitor structure sensing the vibrations of the thin film member as a change in a capacitance. For reference, the microphone element 120 according to the present exemplary embodiment may have any one of the above-mentioned structures. In addition, the microphone element 120 may have a combination of at least two of the above-mentioned structures.

The microphone element 120 may have a sound chamber 124. For example, the microphone element 120 may include the sound chamber 124 amplifying the vibrations of the vibrating part 122. Here, the sound chamber 124 may have a predetermined volume. In addition, the sound chamber 124 may be formed in the front (that is, a side at which the sound wave is input) or the rear of the vibrating part 122. For example, the sound chamber 124 may be omitted if necessary. For example, in the case in which a separate sound chamber is formed in the semiconductor element 110 or the mold 130, the sound chamber 124 may be omitted.

The microphone element 120 configured as described above may be formed on the semiconductor element 110. For example, the microphone element 120 may be formed on one surface of the semiconductor element 110. Here, the microphone element 120 and the semiconductor element 110 may be electrically connected to each other. For example, the microphone element 120 and the semiconductor element 110 may be electrically connected to each other by solder balls 162. To this end, connection terminals may be formed on a lower surface of the microphone element 120 and an upper surface of the semiconductor element 110, respectively. However, the microphone element 120 and the semiconductor element 110 are not limited to being connected to each other in the above-mentioned form. For example, the microphone element 120 and the semiconductor element 110 may also be electrically connected to each other by a connection electrode and a conductive pattern formed in the mold 130.

The mold 130 may accommodate the semiconductor element 110 and the microphone element 120 therein. For example, a thickness t of the mold 130 may be larger than the sum (h1+h2) of a height h1 of the semiconductor element 110 and a height h2 of the microphone element 120. Therefore, side surfaces of the semiconductor element 110 and the microphone element 120 may be completely covered by the mold 130. However, one surface (lower surface based on FIG. 1) of the semiconductor element 110 and one surface (upper surface based on FIG. 1) of the microphone element 120 may be opened to the outside of the mold 130. However, one surface of the semiconductor element 110 may be covered by the mold 130, if necessary. In addition, a portion of one surface of the microphone element 120 may be covered by the mold 130.

The mold 130 may be formed of a material having an excellent insulating property. For example, the mole 130 may be formed of a resin, or the like. In addition, the mold 130 may be formed of a material having elasticity or recovering force. In this case, the mold 130 may be advantageous in protecting the semiconductor element 110 and the microphone element 120 from external impact. However, a material and characteristics of the mold 130 are not limited thereto.

The mold 130 may have the connection electrodes 140 and 142 formed therein. For example, a plurality of connection electrodes 140 and 142 may be formed in the mold 130 by lengthily forming holes in the mold 130 in a thickness direction (vertical direction based on FIG. 1) of the mold 130 and filling conductive materials in the holes.

The connection electrodes 140 and 142 may be connected to the semiconductor element 110. For example, a first connection electrode 140 may connect the semiconductor element 110 and the conductive pattern 150 to each other. In addition, at least one of the connection electrodes 140 and 142 may be connected to a ground terminal. For example, a second connection electrode 142 may connect the conductive pattern 150 and the ground terminal to each other.

The connection electrodes 140 and 142 may be formed of a conductive material. For example, the connection electrodes 140 and 142 may be formed of a material containing Cu, Ag, Au, or the like.

The connection electrodes 140 and 142 may be formed integrally with the conductive pattern 150. That is, the connection electrodes 140 and 142 may be a lead pin extended from the conductive pattern 150.

The conductive pattern 150 may be formed on one surface of the mold 130. For example, the conductive pattern 150 may be formed on an upper surface (based on FIG. 1) of the mold 130. The conductive pattern 150 may include one or more circuit patterns. For example, the conductive pattern 150 may include circuit patterns connecting different connection electrodes 140 and 142 to each other. In addition, the conductive pattern 150 may include a shielding pattern. For example, the conductive pattern 150 may have a pattern shape capable of shielding the semiconductor element 110 and the microphone element 120 from harmful electromagnetic waves. To this end, the conductive pattern 150 may entirely cover one surface of the mold 130. In addition, the conductive pattern 150 may contain a component capable of blocking the harmful electromagnetic waves.

Meanwhile, the conductive pattern 150 may have a plurality of holes 152 formed therein. For example, a hole 152 connected to the microphone element 120 may be formed in the conductive pattern 150. Here, the hole 152 may be used as an inlet through which the sound wave is input.

In addition, the conductive pattern 150 may have a form of a lead frame. For example, the conductive pattern 150 may have a form of a frame including a plurality of lead pins 152 and 154 (See FIG. 11) connected to at least one of the microphone element 120, the semiconductor element 110, and the ground terminal. Meanwhile, the respective lead pins 152 and 154 may have solder balls formed thereon.

In the microphone package 100 configured as described above, the semiconductor element 110 and the microphone element 120 may be formed integrally with each other, which may be advantageous in miniaturizing the microphone package 100. Further, in the microphone package 100 according to the present exemplary embodiment, the semiconductor element 110 and the microphone element 120 may be covered by the mold 130, such that the semiconductor element 110 and the microphone element 120 may be effectively protected from the external impact. Further, in the microphone package 100 according to the present exemplary embodiment, the semiconductor element 110 or the microphone element 120 may be connected to an external terminal by the connection electrodes 140 and 142, such that reliability in transmitting an electrical signal may be improved.

Next, other forms of the microphone package will be described with reference to FIGS. 2 through 9. For reference, in the following description, the same components as those of the microphone package according to an exemplary embodiment of the present disclosure described above will be denoted by the same reference numerals and a description thereof will be omitted.

The microphone package 100 according to the present exemplary embodiment may have several modified forms.

As an example, the microphone package 100 may include a plurality of sound chambers 112 and 124, as shown in FIG. 2. Here, a first sound chamber 124 may be formed in the microphone element 120, and a second sound chamber 112 may be formed between the microphone element 120 and the semiconductor element 110. For example, the second sound chamber 112 may be formed in a groove form in one surface of the semiconductor element 110. The microphone package 100 having the above-mentioned form may be advantageous in improving sensitivity of the sound wave through the plurality of sound chambers 112 and 124.

As another example, the microphone package 100 may include a plurality of sound chambers 112 and 124 and a through hole 114, as shown in FIG. 3. Here, the through hole 114 may be used as a path connecting the second sound chamber 124 to the outside.

As another example, the microphone package 100 may be formed so that the vibrating part 122 of the microphone element 120 and the metal patter 150 are adjacent to each other, as shown in FIGS. 4 through 6. The microphone package 100 having the above-mentioned form may be advantageous in increasing a size of a back volume. For example, in the microphone package 100 having the form shown in FIGS. 5 and 6, the first and second sound chambers 124 and 112 may be connected to each other to form one space, thereby further improving the sensitivity of the sound wave.

As another example, the microphone package 100 may be configured so that one side of the microphone element 120 is completely opened, as shown in FIGS. 7 and 8. For example, a size S2 of the hole 152 may be larger than a size S1 of the vibrating part 122. In addition, in the microphone package 100 having this form, the semiconductor element 110 and the microphone element 120 may be connected to each other by connection electrodes 140 and 144 and a conductive pattern 154. For example, the semiconductor element 110 may be connected to a first connection electrode 140, and the microphone element 120 may be connected to a third connection electrode 144. In addition, the first connection electrode 140 and the third connection electrode 144 may be connected to each other by the conductive pattern 154.

For reference, a reference numeral 156 may indicate a portion of the conductive pattern 150 connected to a second connection electrode 142.

As another example, the microphone package 100 may include components connecting the semiconductor element 110 and the microphone element 120 to external electrodes or ground electrodes, respectively, as shown in FIG. 9. For example, the semiconductor element 110 may be connected to the external electrode or the ground electrode through a first connection electrode 140, a conductive pattern 156, and a second connection electrode 142. In addition, the microphone element 120 may be connected to the external electrode or the ground electrode through a third connection electrode 144, a conductive pattern 158, and a second connection electrode 142.

Next, a method of manufacturing a microphone package according to an exemplary embodiment of the present disclosure will be described with reference to FIG. 10. For reference, a method of manufacturing any one of the microphone packages described above is shown in FIG. 10. However, the method of manufacturing a microphone package shown in FIG. 10 is only an example, and a method of manufacturing another form of microphone package may be used.

The method of manufacturing a microphone package according to the exemplary embodiment of the present disclosure may include forming a microphone element on a semiconductor element, forming a conductive pattern (lead frame), and forming a mold accommodating the semiconductor element and the microphone element therein.

1) Operation of Forming Microphone Element

In this operation, the microphone element 120 may be formed on the prepared semiconductor element 110. For example, the microphone element 120 may be formed on one surface of the semiconductor element 110. Here, the semiconductor element 110 and the microphone element 120 may be electrically connected to each other by the solder balls.

2) Operation of Forming Conductive Pattern (Lead Frame)

In this operation, the lead frame may be formed on the semiconductor element 110 and the microphone element 120. For example, the lead frame 150 provided with a plurality of lead pins 152 and 154 may be disposed on one side of the semiconductor element 110 and the microphone element 120.

The lead frame 150 formed in this operation may be connected to one or more elements or terminals. For example, some of the lead pins 152 and 154 may be connected to the semiconductor element 110, and the other thereof may be connected to the ground terminal. In addition, some of the lead pins or the lead frame may be connected to the microphone element 120.

This operation may include a process of forming solder balls. For example, the solder balls for electrical connection with the semiconductor element 110 and the microphone element 120 may be formed on the lead frame 150 or the lead pins 152 and 154.

3) Operation of Forming Mold

In this operation, the mold 130 enclosing the semiconductor element 110 and the microphone element 120 may be formed. For example, the mole 130 may be formed by seating the semiconductor element 110 and the microphone element 120 in a predetermined frame and injecting a material, which is a raw material of the mold 130, into the frame.

4) Operation of Etching Lead Frame

Meanwhile, the method of manufacturing a microphone package according to the exemplary embodiment of the present disclosure may further include etching the lead frame (See FIG. 11). This operation may include a process of forming a circuit pattern on the lead frame 150. For example, in this operation, a predetermined pattern may be formed on the lead frame 150 by etching the lead frame 150. The pattern may be used for various uses such as a circuit pattern, an antenna pattern, and the like.

Next, a method of manufacturing a microphone package according to another exemplary embodiment of the present disclosure will be described with reference to FIG. 12.

The method of manufacturing a microphone package according to the present exemplary embodiment may include forming a microphone element on a semiconductor element, forming a mold accommodating the semiconductor element and the microphone element therein, forming one or more connection electrodes in the mold, and forming a conductive pattern on the mold, the conductive pattern being connected to the connection electrode.

1) Operation of Forming Microphone Element

In this operation, the microphone element 120 may be formed on the prepared semiconductor element 110. For example, the microphone element 120 may be formed on one surface of the semiconductor element 110. Here, the semiconductor element 110 and the microphone element 120 may be electrically connected to each other by the solder balls.

2) Operation of Forming Mold

In this operation, the mold 130 enclosing the semiconductor element 110 and the microphone element 120 may be formed. For example, the mole 130 may be formed by seating the semiconductor element 110 and the microphone element 120 in a predetermined frame and injecting a material, which is a raw material of the mold 130, into the frame.

3) Operation of Forming Connection Electrodes

In this operation, the connection electrodes 140 and 142 may be formed in the mold 130. For example, the connection electrodes 140 and 142 may be formed by forming holes in the mold 130 by a chemical or mechanical process and filling a conductive material in the holes. Here, one or more connection electrodes 140 and 142 may be connected to the external terminal. In addition, one or more connection electrodes 140 and 142 may be connected to the semiconductor element 110 or the microphone element 120.

4) Operation of Forming Conductive Pattern

In this operation, the conductive pattern 150 may be formed on the mold 130. For example, the conductive pattern 150 may be formed on one surface of the mold 130. In addition, the conductive pattern 150 may also be formed on a side surface of the mold 130. For example, the conductive pattern 150 may include circuit patterns connecting the plurality of connection electrodes 140 and 142 to each other. In addition, the conductive pattern 150 may contain a pattern capable of blocking harmful electromagnetic waves. Further, the conductive pattern 150 may contain a component capable of blocking the harmful electromagnetic waves.

As set forth above, according to exemplary embodiments of the present disclosure, the microphone package may be miniaturized and may be easily manufactured.

While exemplary embodiments have been shown and described above, it will be apparent to those skilled in the art that modifications and variations could be made without departing from the spirit and scope of the present disclosure as defined by the appended claims.

What is claimed is:

1. A microphone package comprising:
a microphone element formed on a semiconductor element;
a mold enclosing the semiconductor element and the microphone element; and
a conductive pattern formed on one surface of the mold and having a hole formed therein, the hole being connected to the microphone element.

2. The microphone package of claim 1, wherein the mold has a first connection electrode formed therein, the first connection electrode being connected to the semiconductor element.

3. The microphone package of claim 1, wherein the mold has a second connection electrode formed therein, the second connection electrode being connected to an external ground electrode.

4. The microphone package of claim 1, wherein the microphone element is connected to the conductive pattern.

5. The microphone package of claim 1, wherein the conductive pattern is a circuit pattern forming one or more electrical circuits.

6. The microphone package of claim 1, wherein the conductive pattern shields harmful electromagnetic waves.

7. The microphone package of claim 1, wherein the conductive pattern has a form of a lead frame including a lead pin connected to at least one of the microphone element and the semiconductor element.

8. The microphone package of claim 1, wherein the mold has first and third connection electrodes formed therein, the first and third connection electrodes being connected to the semiconductor element and the microphone element, respectively, and
the conductive pattern includes one or more circuit patterns connecting the first and third connection electrodes to each other.

9. The microphone package of claim 1, wherein the microphone element is disposed on one surface of the semiconductor element.

10. The microphone package of claim 1, wherein the semiconductor element has a sound chamber formed therein, the sound chamber being connected to the microphone element and being used as a reverberating space for sound waves.

11. The microphone package of claim 1, wherein the semiconductor element has a through hole formed therein, the through hole being connected to the microphone element.

12. The microphone package of claim 1, wherein the semiconductor element has a sound chamber and a through hole formed therein, the sound chamber being used as a reverberating space for sound waves, and the through hole being connected to the sound chamber.

13. The microphone package of claim 1, wherein the microphone element is any one of a piezoresistive type microphone element, a piezoelectric type microphone element, and a condenser type microphone element.

14. A method of manufacturing a microphone package, comprising:
forming a microphone element on a semiconductor element;
forming a lead frame having a lead pin connected to at least one of the semiconductor element and the microphone element; and
forming a mold between the lead frame, and the semiconductor element and the microphone element.

15. The method of manufacturing a microphone package of claim 14, further comprising forming a solder ball on the lead pin.

16. A method of manufacturing a microphone package, comprising:
forming a microphone element on a semiconductor element;
forming a mold accommodating the semiconductor element and the microphone element therein;
forming one or more connection electrodes in the mold; and
forming a conductive pattern on the mold, the conductive pattern being connected to the connection electrodes.

17. The method of manufacturing a microphone package of claim 16, further comprising forming a sound chamber in the semiconductor element, the sound chamber being used as a reverberating space for sound waves.

18. The method of manufacturing a microphone package of claim 16, further comprising forming a through hole connected to the microphone element while penetrating through the semiconductor element.
